(19) United States
(12) Patent Application Publication
(10) Pub. No.: US 2014/0073719 A1
(43) Pub. Date: Mar. 13, 2014

(54) SYNTHESIS OF SUPERHYDROPHOBIC COPOLYMER USING CARBON DIOXIDE SOLVENT AND APPLICATION THEREOF

(71) Applicants: In Park, Seocho-gu (KR); Ha Soo Hwang, Bupyeong-gu (KR); Jin Kie Shim, Seocho-gu (KR); Jun Young Lee, Yongin-si (KR); Sang Bong Lee, Anyang-si (KR); Kye Min Cho, Gangnam-gu (KR)

(72) Inventors: In Park, Seocho-gu (KR); Ha Soo Hwang, Bupyeong-gu (KR); Jin Kie Shim, Seocho-gu (KR); Jun Young Lee, Yongin-si (KR); Sang Bong Lee, Anyang-si (KR); Kye Min Cho, Gangnam-gu (KR)

(73) Assignee: KOREA INSTITUTE OF INDUSTRIAL TECHNOLOGY, Cheonan-si, Chungcheongnam-do (KR)

(21) Appl. No.: 13/997,626

(22) PCT Filed: Dec. 23, 2011
(86) PCT No.: PCT/KR2011/010064

§ 371 Date: Sep. 18, 2013

(30) Foreign Application Priority Data
Dec. 24, 2010 (KR) 10-2010-0134863

(51) Int. Cl. C09D 7/12

(52) U.S. Cl. CPC C09D 7/1216
USPC 523/400; 524/700

(57) ABSTRACT

A method for preparing a superhydrophobic random copolymer using a carbon dioxide solvent, and more particularly, to a method for preparing a surface coating copolymer having a superhydrophobic performance by radical copolymerization of a hydrocarbon monomer, and a silicone monomer or a fluorinated monomer using a supercritical carbon dioxide solvent as a copolymerization solvent.

### BACKGROUND OF THE INVENTION

1. Field of the Invention

The present invention relates to a method for preparing a superhydrophobic copolymer by random copolymerization of a methacrylate-based monomer or a styrene-based monomer containing a silyloxysilyl group or a perfluoroalkyl group and a methacrylate-based monomer containing a methyl group or a glycidyl group under an environmentally friendly carbon dioxide solvent, and a method for manufacturing a superhydrophobic article by coating with the superhydrophobic copolymer.

2. Description of the Related Art

A great amount of organic or halogenated solvents are used worldwide each year as polymerization solvents, cleaning agents, and dispersants. All conventional solvents present health risks, safety risks, and are environmentally detrimental. In particular, petroleum-based solvents are flammable and smog producing, and the use of non-volatile solvents such as aqueous solutions, instead of volatile solvents, has major disadvantages in generating waste water and requiring a lot of time and energy for drying after cleaning.

For this reason, carbon dioxide has been proposed as an alternative solvent, because it is nontoxic, nonflammable, inexpensive, and environmentally friendly. There are advantages in that carbon dioxide easily reaches the supercritical state, because of its low critical temperature (31.1° C.) and critical pressure (73.8 bar), it is easy to change the density and the solvent strength by changing pressure, owing to its high compressibility in the supercritical state, and a solvent can be simply separated from a solute because carbon dioxide has a gaseous state under reduced pressure. That is, synthesized polymer materials can be easily separated from carbon dioxide, and thus it is preferred to recover valuable materials and to treat waste products. Further, because a large amount of the carbon dioxide solvent can be obtained from the air and from byproducts of various chemical processes, a separate production process is not needed, and used carbon dioxide can be further reused through recycling.

With respect to the copolymer to be synthesized in the present invention, its monomer has good solubility for carbon dioxide, and the prepared copolymer has also a high affinity for carbon dioxide, which is advantageous in spray coating.

However, snow or ice adheres to the surface of an object and is laminated thereon in cold areas, which can cause mechanical defects or dysfunction of the object, as well as the disaster caused by the fall thereof. As a solution to these problems, superhydrophobic technology is applied to prevent adhesion of snow or ice by coating the surface of the object with a superhydrophobic material.

In order to have super-hydrophobic/oleophobic properties, the surface of the material should have low surface energy, micro/nano-sized three-dimensional structure. To this end, a polymer material having low surface energy is required, and the polymer material manufactured has good solubility for carbon dioxide. Thus, it is possible to coat the material with a carbon dioxide solvent.

Surface coating materials have been used in a variety of industrial applications such as paints, adhesives, textiles, fine chemical industries, electronics, automotives, shipbuilding industries and the like.

There are many types of polymer materials used as surface coating agents, but polymer materials with superhydrophobic performance show great applicability because they also have the functions of antifouling, lubricity, low surface energy and the like. These polymer materials with excellent superhydrophobic performance can be produced from copolymers that are prepared by radical polymerization of silicon- and fluorine-based monomers as main monomers and a hydrocarbon-based monomer as an auxiliary monomer.

The oil consisting of silicon functional groups and fluorine functional groups contained in the silicon- and fluorine-based monomers is a highly hydrophobic material having the surface tension of 21 mJ/m² and 18 mJ/m² or less, and these silicon functional groups and fluorine functional groups have the lowest surface energy among the functional groups of the existing materials. Owing to their low surface energy, these silicon functional groups and fluorine functional groups are oriented toward the air when applied to the surface of the material, and thus they exhibit unique superhydrophobic performance.

On the other hand, the known method for preparing the surface coating material is to copolymerize a vinyl-based monomer containing a silicon or fluorine functional group and a hydrocarbon-based vinyl monomer under a carbon dioxide solvent using a radical polymerization initiator. This method is simple and exhibits excellent performance.

In more detail, a superhydrophobic polymer can be prepared by random copolymerization of a methacrylate-based or styrene-based monomer in the presence of a polymerization initiator under the carbon dioxide solvent, and examples of the monomer may include a methacrylate-based monomer containing a trimethylsilyloxysilyl group or a perfluoroalkyl group (e.g., SiMA or Zonyl™). The physical and chemical properties of the copolymer can be controlled by adjusting the content of the above monomer, and the solubility for carbon dioxide increases as the content of the monomer increases. In particular, an increase in the amount of the perfluoroalkyl-based monomer reduces the copolymer solubility for common organic solvents, but greatly increases its solubility for the carbon dioxide solvent. In other words, it is difficult to increase the content of the perfluoroalkyl-based monomer in the copolymerization with common solvents, but its content can be favorably increased up to 100% with the carbon dioxide solvent. Therefore, there is a need to synthesize the copolymer with excellent superhydrophobic properties by selecting appropriate monomers and concentrations thereof under the carbon dioxide solvent to adjust the physical and chemical properties of the copolymer.

Accordingly, the present inventors have researched a method for preparing a superhydrophobic copolymer using a carbon dioxide solvent, and synthesized a random copolymer by radical copolymerization between a silicone-based or fluorine-based vinyl monomer and a hydrocarbon-based vinyl monomer under a carbon dioxide solvent. As a result, they found that this copolymer exhibits excellent superhydrophobic performance when applied to the surface of a material under the carbon dioxide solvent, thereby completing the present invention.

### SUMMARY OF THE INVENTION

An object of the present invention is to provide a method for preparing a superhydrophobic random copolymer for surface coating, which has greatly improved hydrophobicity upon surface coating and has good solubility for carbon dioxide, and thus shows excellent superhydrophobic performance without the use of additional organic solvents and emulsifiers.

Another object of the present invention is to provide a method for manufacturing a superhydrophobic article by coating the superhydrophobic copolymer under a carbon dioxide solvent.

### BRIEF DESCRIPTION OF THE DRAWINGS

FIG. 1 shows the ¹H NMR result according to Example 1;

FIG. 2 shows the ¹H NMR result according to Example 2;

FIG. 3 shows the ¹H NMR result according to Example 3;

FIG. 4 is an image showing the water contact angle of a polymer that was spin-coated on a slide glass ((A) poly(SiMA), (B) poly(SiMA-co-MMA), (C) poly(Zonyl-co-MMA)); and

FIGS. 5a to 5c are images of SEM and the water contact angle of a polymer that was spray-coated on a slide glass ((a) poly(SiMA), (b) poly(SiMA-co-MMA), (c) poly(Zonyl-co-MMA)).

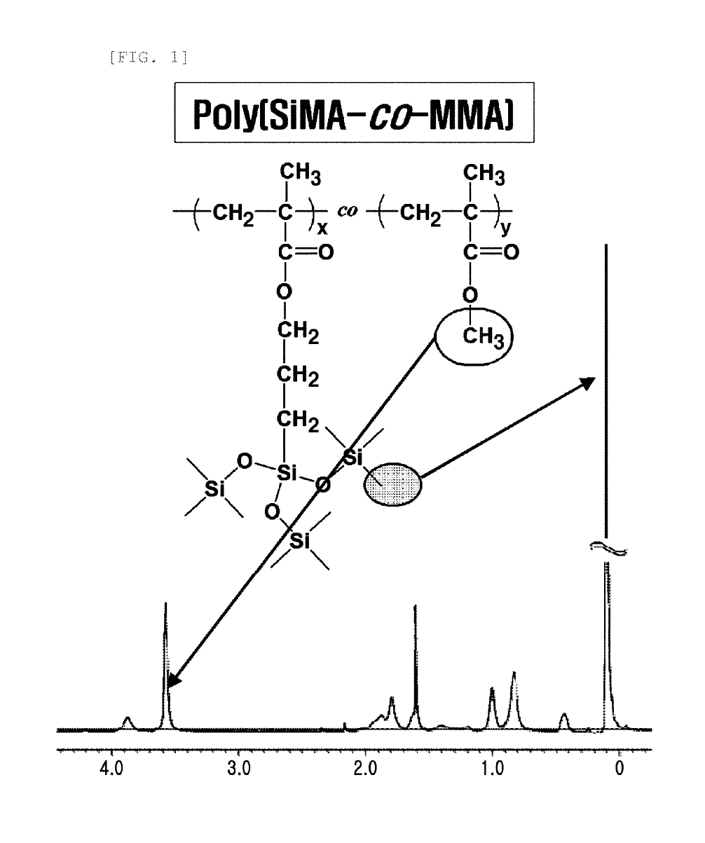

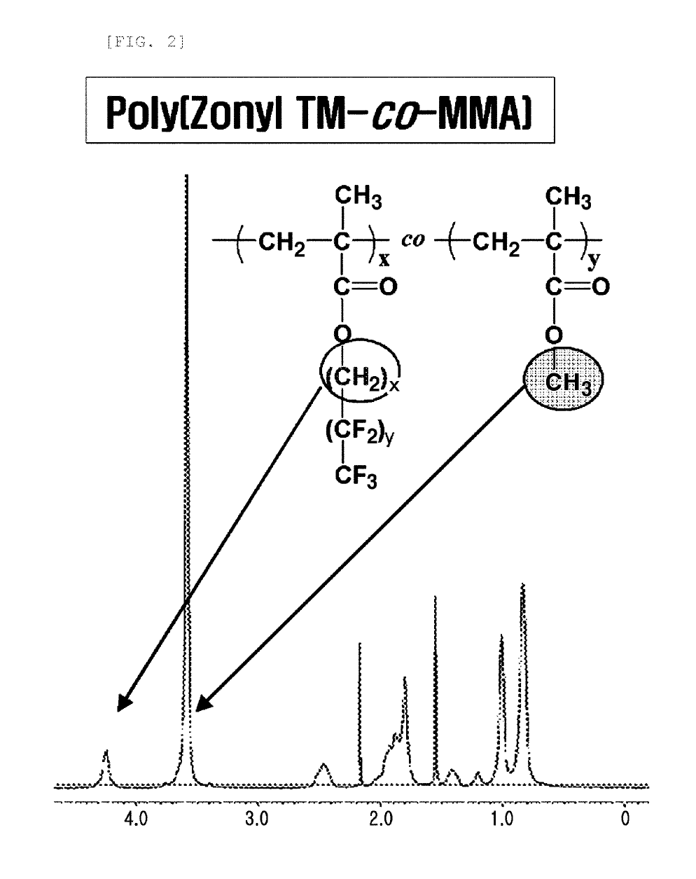

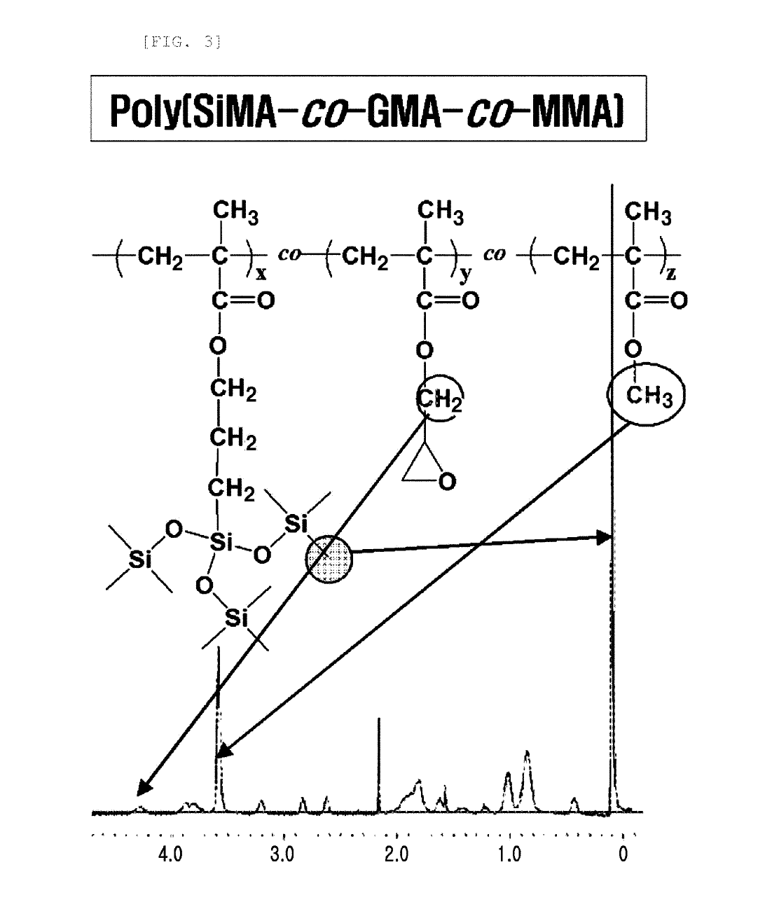

### DETAILED DESCRIPTION OF THE PREFERRED EMBODIMENTS

In order to achieve the above objects, an aspect of the present invention provides a method for preparing a superhydrophobic random copolymer represented by the following Chemical Formula (I), comprising conducting a random copolymerization of a mixture of the monomers represented by the following Chemical Formula (III) and Chemical Formula (IV) under a carbon dioxide solvent in the presence of a polymerization initiator.

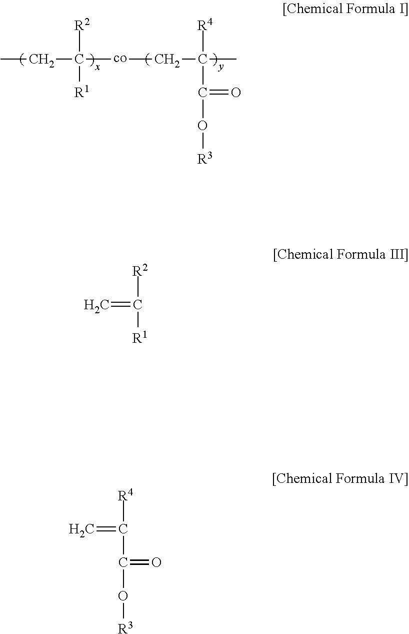

wherein,

R¹ is COO(CH₂)ₘ—Si(OSi(CH₃)₃)₃), COO(CH₂)ₙ(CF₂)ₒ—CF₃ or phenyl,

R² is hydrogen or C₁₋₃ alkyl,

R³ is hydrogen, C₁₋₃ alkyl or oxiranyl(C₁₋₃ alkyl),

R⁴ is hydrogen or C₁₋₃ alkyl,

x is 1 to 10000 and y is 1 to 10000, and

n is 1 to 4, m is 1 to 4, and o is 0 to 13.

In one preferred embodiment of Chemical Formula (I) in the present invention, R² is hydrogen or methyl, R³ is hydrogen, methyl, or oxiranylmethyl, and R⁴ is hydrogen or methyl.

In the preferred embodiment, R¹ is COO(CH₂)₂—Si (OSi (CH₃)₃)₃ or COO(CH₂)ₙ(CF₂)ₒ—CF₃ (n is 1 to 4, and o is 0 to 13) and R² is C₁₋₃ alkyl, or R¹ is phenyl and R² is hydrogen.

In the preferred embodiment, R³ and R⁴ are each hydrogen, or R³ and R⁴ are each C₁₋₃ alkyl, or R³ is oxiranyl(C₁₋₃ alkyl) and R⁴ is methyl.

As used herein, the term “carbon dioxide” refers to liquid carbon dioxide generated at a high pressure. The carbon dioxide solvent used in the above polymerization has a temperature ranging from 50° C. to 100° C. and a pressure ranging from 150 bar to 500 bar.

As used herein, the term “superhydrophobic” means that the surface of a solid has a contact angle of 150° or higher and a sliding angle of 10° or lower due to protrusions on the solid surface, when it is in contact with a liquid, namely, water, and thus the contract area is minimized and water droplets form or roll off from the protrusions.

As used herein, the term “random copolymer” refers to a copolymer generated by the random arrangement of two or more of the monomers that constitute the copolymer.

As used herein, the term “methacrylate-based” refers to a compound in a form of H₂C═C(CH₃)C(═O)OR. R of the methacrylate-based monomer used in the present invention may include —(CH₂)₂—Si(OSi(CH₃)₃)₃, —(CH₂)₂—(CF₂)ₒ—CF₃ (o is 1 to 8), —(CH₂)ₓ—CH₃ (x is 0 to 12), an epoxy functional group, hydrogen or the like.

As used herein, the term “styrene-based” refers to a compound in a form of CH₂═CH-phenyl, in which a double bond is conjugated with a benzene ring, and a derivative thereof.

As used herein, the term “SiMiA” refers to 3-[tris(trimethylsilyloxy)silyl]-propyl methacrylate.

As used herein, the term “Zonyl™” refers to a mixture of fluoroalkylmethacrylate that is manufactured by Dupont.

As used herein, the term “MMA” refers to methylmethacrylate.

As used herein, the term “GMA” refers to glycidylmethacrylate.

As used herein, the term “AA” refers to acrylic acid.

Examples of the superhydrophobic random copolymer represented by Chemical Formula (I) may include

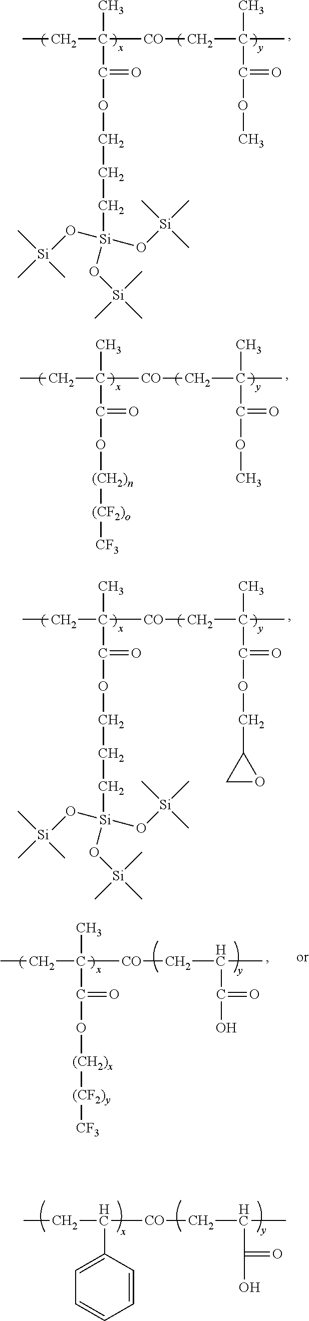

(wherein x is 1 to 10000, and y is 1 to 10000).

The monomer of Chemical Formula (III) and the monomer of Chemical Formula (IV) are preferably used in a weight ratio of 1 to 10000:1 to 10000.

As used herein, the term “polymerization initiator” refers to a substance that reacts with the monomer of Chemical Formula (III) or (IV) to form an intermediate, thereby inducing polymerization initiation. The polymerization initiator is a radical polymerization initiator, and specific examples thereof may include azobisisobutyronitrile (AIBN), di-t-butyl peroxide, benzoyl peroxide or 1,1′-azobis(cyclohexanecarbonitrile) or the like, but are not limited thereto.

The polymerization initiator is preferably used in an amount of 0.1 to 10% by weight, based on the total weight of the monomer.

Another aspect of the present invention provides a method for preparing a superhydrophobic random copolymer represented by the following Chemical Formula (II), comprising conducting a random copolymerization of a mixture of the monomers represented by the following Chemical Formula (III), Chemical Formula (IV) and Chemical Formula (V) under a carbon dioxide solvent in the presence of a polymerization initiator.

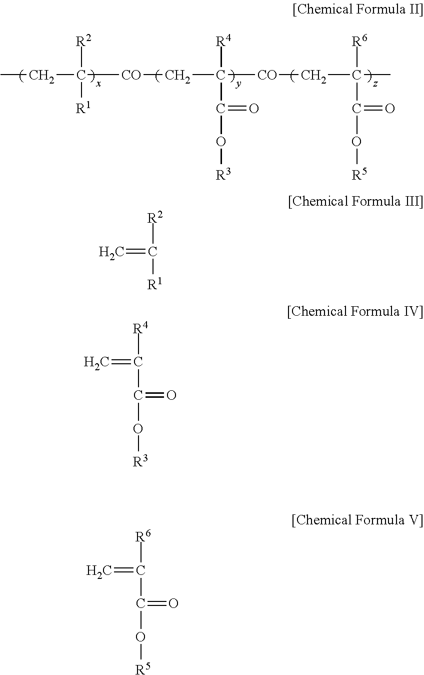

wherein,

R¹ is COO(CH₂)ₘ—Si(OSi(CH₃)₃)₃, COO(CH₂)ₙ(CF₂)ₒ—CF₃ or phenyl,

R² is hydrogen or C₁₋₃ alkyl,

R³ is hydrogen, C₁₋₃ alkyl or oxiranyl(C₁₋₃ alkyl),

R⁴ is hydrogen or C₁₋₃ alkyl,

R⁵ is hydrogen or C₁₋₃ alkyl, but is not, identical to R³,

R⁶ is hydrogen or C₁₋₃ alkyl,

x is 1 to 10000, y is 1 to 10000, and z is 1 to 10000, and

n is 1 to 4, m is 1 to 4, and o is 0 to 13.

In one preferred embodiment of Chemical Formula (II) in the present invention, R² is hydrogen or methyl, R³ is hydrogen, methyl, or oxiranylmethyl, R⁴ is hydrogen or methyl, R⁵ is methyl or oxiranylmethyl, and R⁶ is methyl.

In the preferred embodiment, R¹ is COO(CH₂)₂—Si(OSi(CH₃)₃)₃ or COO(CH₂)ⁿ(CF₂)ₒ—CF₃ (n is 1 to 4, and o is 0 to 13) and R² is C₁₋₃ alkyl, or R¹ is phenyl and R² is hydrogen.

In the preferred embodiment, R³ and R⁴ are each hydrogen, or R³ and R⁴ are each C₁₋₃ alkyl, or R³ is oxiranyl(C₁₋₃ alkyl) and R⁴ is methyl.

In the preferred embodiment, R⁵ and R⁶ are each C₁₋₃ alkyl.

The example of the superhydrophobic random copolymer represented by Chemical Formula (II) may include

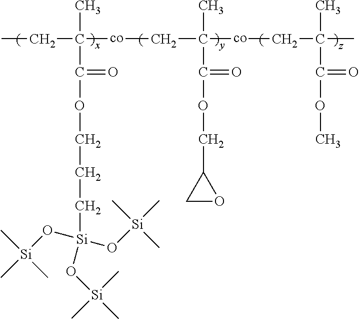

(wherein x is 1 to 10000, y is 1 to 10000, and z is 1 to 10000).

In the present invention, the coating may be performed by a spray coating method.

The superhydrophobic random copolymer according to the present invention may have different characteristics depending on the ratio between x and y, or x, y and z, and the preferred total molecular weight is 10,000 to 10,000,000.

The monomers represented by Chemical Formula (III), Chemical Formula (IV) and Chemical Formula (V) are preferably used in a weight ratio of 1 to 10000:1 to 10000:1 to 10000.

The polymerization initiator is preferably used in an amount of 0.1 to 10% by weight, based on the total weight of the monomers.

Still another aspect of the present invention provides a method for manufacturing a superhydrophobic article by coating the superhydrophobic random copolymer, which is represented by Chemical Formula (I) or (II) and prepared by the above preparation method, to the surface of the article under the carbon dioxide solvent.

In the present invention, examples of the article may include textiles, automotive, paints, films or the like.

Hereinafter, the preferred Examples are provided for better understanding. However, the following Examples are for illustrative purposes only, and the invention is not intended to be limited by these Examples.

### Comparative Example 1

### Synthesis of poly(3-[tris(trimethylsilyloxy)silyl]-propylmethacrylate; SiMA)

2 g of 3-[tris(trimethylsilyloxy)silyl]-propyl methacrylate and 0.02 g of AIBN with a magnetic (teflon-coated) bar were put in a high-pressure stainless reactor (30 ml), and then carbon dioxide was injected into the reactor using an ISCO syringe (Model 260D) pump, and reacted at 65° C. and 248 bar for 12 hours. After completing polymerization, the reactor was cooled to terminate the reaction. Thereafter, the pressure of the reactor was reduced to discharge carbon dioxide in a gaseous state, and then the produced polymer material was recovered, and dried in high vacuum for 24 hours. The dried product was weighed to calculate the polymer yield, and the compositional ratio of the monomers and molecular weight were determined by ¹H NMR and GPC analysis, respectively.

### Example 1

### Synthesis of poly(SiMA-co-MMA)

1 g of MMA, 0.02 g (2 wt % of monomer) of poly 3-[tris(trimethylsilyloxy)silyl]-propyl methacrylate 2 g, 2 g of methyl methacrylate, and 0.04 of g AIBN with a magnetic (teflon-coated) bar were put in the high-pressure stainless reactor (30 ml), and then carbon dioxide was injected into the reactor using the ISCO syringe (Model 260D) pump, and reacted at 65° C. and 248 bar for 12 hours. After completing polymerization, the reactor was cooled to terminate the reaction. Thereafter, the pressure of the reactor was reduced to discharge carbon dioxide in a gaseous state, and then the produced polymer material was recovered, and dried in high vacuum for 24 hours. The dried product was weighed to calculate the polymer yield, and the compositional ratio of the monomers and molecular weight were determined by ¹H NMR and GPC analysis, respectively.

### Example 2

### Synthesis of poly(Zonyl-co-MMA)

2 g of Zonyl™, 2 g of methyl methacrylate and 0.04 g of AIBN with a magnetic (teflon-coated) bar were put in the high-pressure stainless reactor (30 ml), and then carbon dioxide was injected into the reactor using the ISCO syringe (Model 260D) pump, and reacted at 65° C. and 248 bar for 12 hours. After completing polymerization, the reactor was cooled in ice water and carbon dioxide was slowly removed, and then the product was recovered, and dried in high vacuum for 24 hours. The dried product was weighed to calculate the polymer yield, and the composition and molecular weight of the monomers were determined by ¹H NMR and GPC analysis, respectively.

### Example 3

### Synthesis of poly(SiMA-co-GMA-co-MMA)

2 g 3-[tris(trimethylsilyloxy)silyl]-propyl methacrylate, 1 g of glycidylmethacrylate, 2 g of methyl methacrylate and 0.05 g of AIBN with a magnetic (teflon-coated) bar were put in the high-pressure stainless reactor (30 ml), and then carbon dioxide was injected into the reactor using the ISCO syringe (Model 260D) pump, and reacted at 65° C. and 248 bar for 12 hours. After completing polymerization, the reactor was cooled in ice water and carbon dioxide was slowly removed, and then the product was recovered, and dried in high vacuum for 24 hours. The dried product was weighed to calculate the polymer yield, and the compositional ratio of the monomers and molecular weight were determined by ¹H NMR and GPC analysis, respectively.

The physical properties of the polymers prepared in Comparative Example 1 and Examples 1 to 2 are given in Table 1 below.

TABLE 1

| | SiMA | SiMA | | | | |
|---|---|---|---|---|---|---|
| | (Zonyl) | (Zonyl) | | | | |
| | supply | mixing | | | | Glass |
| | ratio | ratio | | PDI | | transition |
| | (wt/ | (wt/ | Mn | (Mw/ | Yield | temperature |
| Polymer | wt %) | wt %) | (g/mol) | Mn) | (%) | (Tg) (° C.) |
| Comparative | 100 | 100 | 51000 | 1.8 | 72.1 | −33 |
| Example 1 | | | | | | |
| (poly(SiMA)) | | | | | | |
| Example 1 | 50 | 55 | 55000 | 1.9 | 70.5 | 61.6 |
| (poly(SiMA- | | | | | | |
| co-MMA)) | | | | | | |
| Example 2 | 20 | 26 | 64400 | 1.7 | 78.1 | 93.2 |
| poly(Zonyl- | | | | | | |
| co-MMA) | | | | | | |

As shown in Table 1, it was found that the SiMA homopolymer according to Comparative Example 1 showed a considerably low glass transition temperature of −33° C. It was found that the copolymer according to Example 1 having 55% by weight of SiMA showed an increased glass transition temperature of 61.6° C. due to copolymerization with MMA known to have a relatively high glass transition temperature. Further, it was found that poly(Zonyl-co-MMA) of Example 2 showed a glass transition temperature of 93.2° C., and its solubility for carbon oxide is higher than that of the SiMA-containing polymer, and thus a copolymer having a relatively high molecular weight was formed.

### Experimental Example 1

### Surface Energy Analysis of Synthesized Polymer (Measurement of Water Contact Angle by Spin Coating)

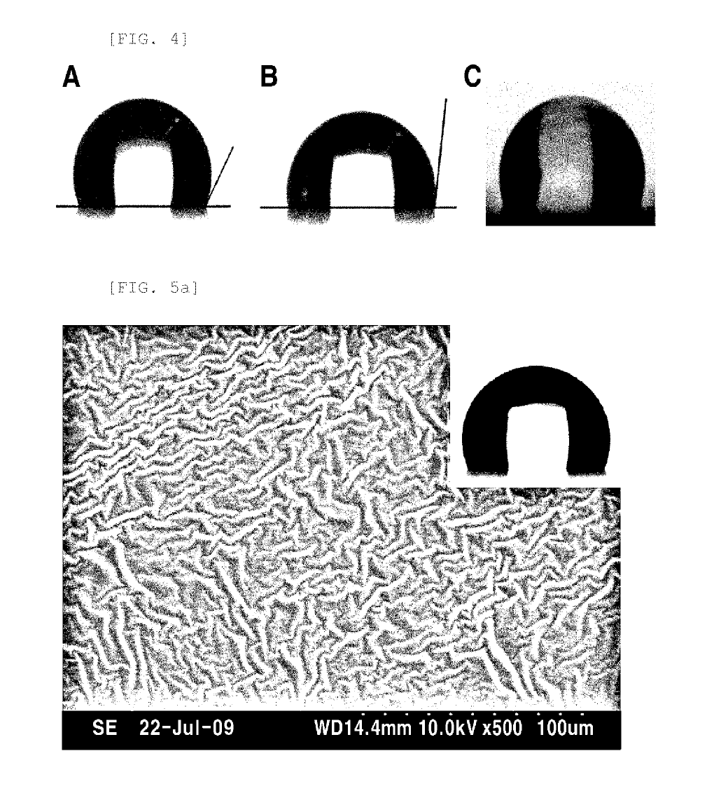

For surface energy analysis of the copolymers prepared in Comparative Example 1 and Examples 1 and 2, each of the polymers was dissolved in acetone, and spin-coated onto a slide glass to measure the static contact angle of water, and the results are shown in FIG. 4.

As shown in FIG. 4, (A) poly(SiMA), (B) poly(SiMA-co-MMA) and (C) poly(Zonyl-co-MMA) had a contact angle of 118°, 97°, and 101°, respectively.

### Experimental Example 2

### Surface Energy Analysis of Synthesized Polymer (Measurement of Water Contact Angle by Spray Coating)

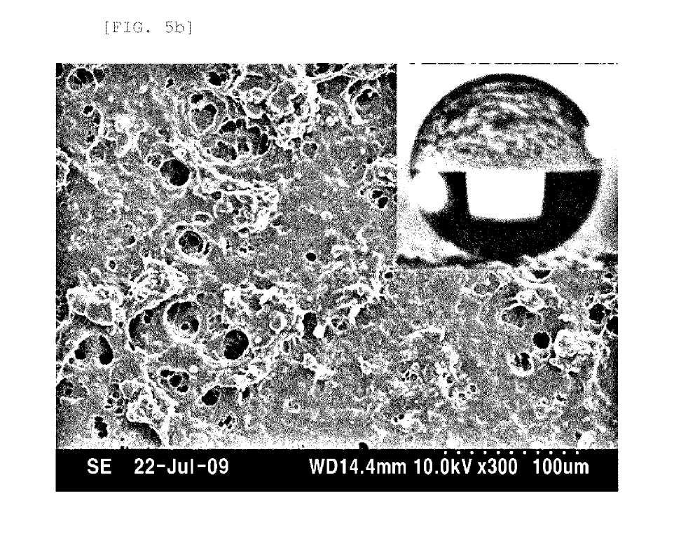

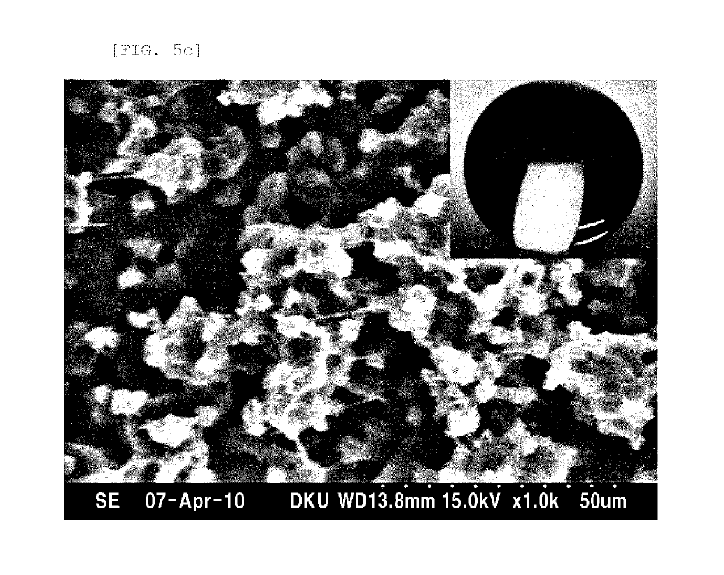

The polymers prepared in Comparative Example 1 and Examples 1 to 2 were dissolved in the carbon dioxide solvent, and then coating was performed using a spray gun, using scanning electron microscopy. The results are shown in FIGS. 5a to 5c.

As shown in FIGS. 5a to 5c, poly(SiMA) showed little surface roughness and had a fiat surface property. Since poly(SiMA) is an amorphous polymer having a glass transition temperature lower than room temperature, micron-sized particles were expected to flow down the surface after spraying, resulting in reduced hydrophobicity.

SEM images of the contact angle showed that (a) poly(SiMA) had a water contact angle of 118°, and both (b) poly(SiMA-co-MMA) and (c) poly(Zonyl-co-MMA) had a water contact angle close to 180°. As shown in SEM images, a binary structure was formed by assembly of submicron-sized polymer particles into new micron-sized particles.

### EFFECT OF THE INVENTION

The superhydrophobic random copolymer according to the present invention has low surface energy and good solubility for carbon dioxide solvent, and thus can be prepared by using carbon dioxide as a solvent. Further, when a surface is coated with the superhydrophobic random copolymer according to the present invention, the surface has low water wettability due to low surface energy of the superhydrophobic random and copolymer, thereby forming a superhydrophobic surface.

1.-10. (canceled)

11. A method for preparing a superhydrophobic random copolymer represented by the following Chemical Formula (I), comprising conducting a random copolymerization of a mixture of the monomers represented by the following Chemical Formula (III) and Chemical Formula (IV) under a carbon dioxide solvent in the presence of a polymerization initiator: 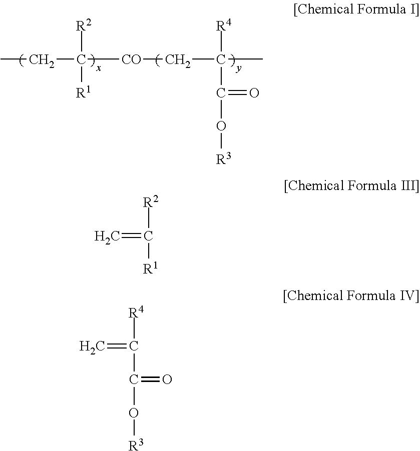
wherein,
R¹ is COO(CH₂)ₘ—Si(OSi(CH₃)₃)₃, COO(CH₂)ₙ(CF₂)ₒ—CF₃ or phenyl,
R² is hydrogen or C₁₋₃ alkyl,
R³ is oxiranyl(C₁₋₃ alkyl),
R⁴ is hydrogen or C₁₋₃ alkyl,
x is 1 to 10000, and y is 1 to 10000, and
n is 1 to 4, m is 1 to 4, and o is 0 to 13.

12. A method for preparing a superhydrophobic random copolymer represented by the following Chemical Formula (II), comprising conducting a random copolymerization of a mixture of the monomers represented by the following Chemical Formula (III). Chemical Formula (IV) and Chemical Formula (V) under a carbon dioxide solvent in the presence of a polymerization initiator: 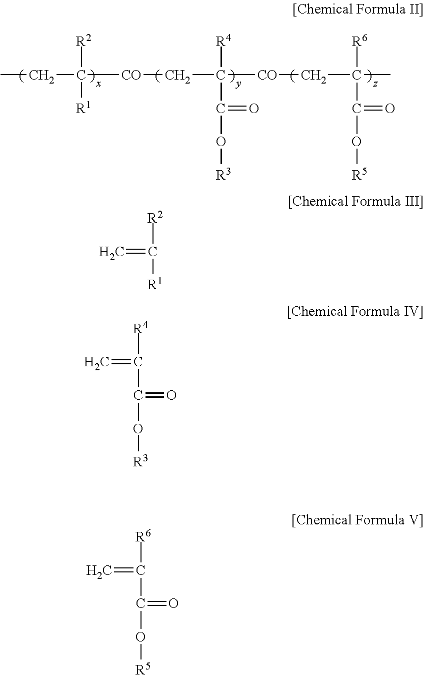
wherein,
R¹ is COO(CH₂)ₘ—Si(OSi(CH₃)₃)₃, COO(CH₂)ₙ(CF₂)ₒ—CF₃ or phenyl,
R² is hydrogen or C₁₋₃ alkyl,
R³ is oxiranyl(C₁₋₃ alkyl),
R⁴ is hydrogen or C₁₋₃ alkyl,
R⁵ is hydrogen or C₁₋₃ alkyl, but is not identical to R³,
R⁶ is hydrogen or C₁₋₃ alkyl,
x is 1 to 10000, y is 1 to 10000, and z is 1 to 10000, and
n is 1 to 4, m is 1 to 4, and o is 0 to 13.

13. The method according to claim 11, wherein the superhydrophobic random copolymer represented by Chemical Formula (I) is

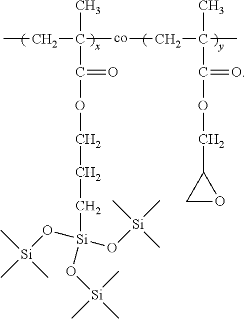

14. The method according to claim 12, wherein the superhydrophobic random copolymer represented by Chemical Formula (II) is

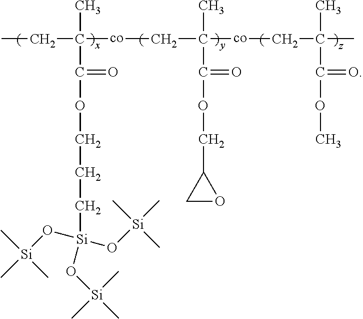

15. The method according to claim 11, wherein the polymerization initiator is azobisisobutyronitrile (AIBN), di-t-butyl peroxide, benzoyl peroxide, or 1,1′-azobis(cyclohexanecarbonitrile).

16. The method according to claim 11, wherein the monomer of Chemical Formula (III) and the monomer of Chemical Formula (IV) are used in a weight ratio of 1 to 10000:1 to 10000.

17. The method according to claim 12, wherein the monomer of Chemical Formula (III), the monomer of Chemical Formula (IV), and the monomer of Chemical Formula (V) are used in a weight ratio of 1 to 10000:1 to 10000:1 to 10000.

18. The method according to claim 11, wherein the polymerization initiator is used in an amount of 0.1 to 10% by weight, based on the total weight of the monomer.

19. A method for manufacturing a superhydrophobic article by coating the superhydrophobic random copolymer prepared by the method of claim 11 to the surface of the article under a carbon dioxide solvent.

20. The method according to claim 19, wherein the article is a textile, an automotive, a paint, or a film.

21. The method according to claim 12, wherein the polymerization initiator is azobisisobutyronitrile (AIBN), di-t-butyl peroxide, benzoyl peroxide, or 1,1′-azobis(cyclohexanecarbonitrile).

22. The method according to claim 12, wherein the polymerization initiator is used in an amount of 0.1 to 10% by weight, based on the total weight of the monomer.

23. The method for manufacturing a superhydrophobic article by coating the superhydrophobic random copolymer prepared by the method of claim 12 to the surface of the article under a carbon dioxide solvent.
